(19) United States
(12) Patent Application Publication
(10) Pub. No.: US 2002/0030454 A1
(43) Pub. Date: Mar. 14, 2002

(54) Arc lamp power supply

(75) Inventor: David P. Stumbo, Belmont, CA (US)

Correspondence Address: KOLISCH, HARTWELL, DICKINSON,, McCORMACK & HEUSER, 520 S.W. Yamhill Street, Suite 200, Portland, OR, 97204, US

(73) Assignee: Molecular Devices Corporation

(21) Appl. No.: 09/836,575

(22) Filed: Apr. 16, 2001

Related U.S. Application Data
(60) Provisional application No. 60/190,265, filed on Mar. 17, 2000.
(60) Provisional application No. 60/178,026, filed on Jan. 26, 2000.
(60) Provisional application No. 60/191,890, filed on Mar. 23, 2000.
(60) Provisional application No. 60/197,324, filed on Apr. 14, 2000.
(60) Provisional application No. 60/200,530, filed on Apr. 27, 2000.
(60) Provisional application No. 60/218,231, filed on Jul. 14, 2000.
(60) Provisional application No. 60/222,222, filed on Aug. 1, 2000.
(60) Provisional application No. 60/223,642, filed on Aug. 8, 2000.
(60) Provisional application No. 60/241,032, filed on Oct. 17, 2000.
(60) Provisional application No. 60/244,012, filed on Oct. 27, 2000.
(60) Provisional application No. 60/250,681, filed on Nov. 30, 2000.
(60) Provisional application No. 60/250,683, filed on Nov. 30, 2000.
(60) Provisional application No. 60/267,639, filed on Feb. 10, 2001.

(51) Int. Cl. H05B 37/02

(52) U.S. Cl. 315/291; 315/276

(57) ABSTRACT

Xenon arc lamp systems having improved high-voltage power supplies, particularly for use in spectroscopic applications.

### CROSS-REFERENCES

This application is based upon and claims benefit under 35 U.S.C. § 119 of the following U.S. provisional patent application, which is incorporated herein by reference: Serial No. 60/190,265, filed Mar. 17, 2000.

This application incorporates by reference the following U.S. Pat. No. 5,843,378, issued Dec. 1, 1998; No. 6,965,381, issued Oct. 12, 1999; No. 6,071,748, issued Jun. 6, 2000; and No.6,097,025, issued Aug. 1, 2000.

This application incorporates by reference the following U.S. patent applications: Ser. No. 08/840,553, filed Apr. 14, 1997; Ser. No. 09/118,141, filed Jul 16, 1998; Ser. No. 09/144,578, filed Aug. 31, 1998; Ser. No. 09/156,318, filed Sep. 18, 1998; Ser. No. 09/349,733, filed Jul. 8, 1999; Ser. No. 09/478,819, filed Jan. 5, 2000; Ser. No. 09/596,444, filed Jun. 19, 2000; Ser. No. 09/626,208, filed Jul. 26, 2000; Ser. No. 09/643,221, filed Aug. 18, 2000; Ser. No. 09/710,061, filed Nov. 10, 2000; Ser. No. 09/722,247, filed Nov. 24, 2000; Ser. No. 09/733,370, filed Dec. 8, 2000; Ser. No. 09/759,711, filed Jan. 12, 2001; Ser. No. 09/765,869, filed Jan. 19, 2001; Ser. No. 09/765,874, filed Jan. 19, 2001; Ser. No. 09/766,131, filed Jan. 19, 2001; Ser. No. 09/767,316, filed Jan. 22, 2001; Ser. No. 09/767,434, filed Jan. 22, 2001; Ser. No. 09/767,579, filed Jan. 22, 2001; Ser. No. 09/767,583, filed Jan. 22, 2001; Ser. No. 09/768,661, filed Jan. 23, 2001; Ser. No. 09/768,765, filed Jan. 23, 2001; Ser. No. ______; filed Jan. 23, 2001, entitled Improvements in Luminescence Assays, and naming Ewald A. Terpetschnig, John C. Owicki, and Sudhir S. Deshpande as inventors; Ser. No. 09/770,720, filed Jan. 25, 2001; Ser. No. 09/770,724 filed Jan. 25, 2001; Ser. No. 09/777,343, filed Feb. 5, 2001; and Ser. No. ______, filed Mar. 19, 2001, entitled, Methods and Apparatus for Bioanalytical Detection of Single Particles Using Luminescence Polarization, and naming Douglas N. Modlin and Todd E. French as inventors.

This application also incorporates by reference the following U.S. provisional patent applications: Serial No. 60/178,026, filed Jan. 26, 2000; Serial No. 60/191,890, filed Mar. 23, 2000; Serial No. 60/197,324, filed Apr. 14, 2000; Serial No. 60/200,530, filed April 27, 2000; Serial No. 60/218,231, filed Jul. 14, 2000; Serial No. 60/222,222, filed Aug. 1, 2000; Serial No. 60/223,642, filed Aug. 8, 2000; Serial No. 60/241,032, filed Oct. 17, 2000; Serial No. 60/244,012, filed Oct. 27, 2000; Serial No. 60/250,681, filed Nov. 30, 2000; Serial No. 60/250,683, filed Nov. 30, 2000; and Serial No. 60/267,639, filed Feb. 10, 2001.

This application also incorporates by reference the following publication: Joseph R. Lakowicz, Principles of Fluorescence Spectroscopy (2^{nd} Edition 1999).

### FIELD OF THE INVENTION

The present invention relates to arc lamps, and more particularly to xenon arc lamps having improved high-voltage power supplies for use in spectroscopic applications.

### BACKGROUND OF THE INVENTION

Light sources may be used to produce light for spectroscopic and other applications. These light sources generally include a lamp to produce light and a power supply to provide power for the lamp. A preferred light source for many spectroscopic applications, including photoluminescence assays, is a xenon arc lamp, as described in the following patents and patent applications, each of which is incorporated herein by reference: U.S. Pat. No. 6,097,025, issued Aug. 1, 2000; U.S. patent application Ser. No. 09/349,733, filed Jul. 8, 1999; U.S. patent application Ser. No. 09/777,343, filed Feb. 5, 2001; and U.S. Provisional Patent Application Serial No. 60/197,324, filed Apr. 14,2000.

FIG. 1 shows a xenon arc lamp and a typical housing for the lamp. The lamp includes an anode, a cathode, and a high-pressure xenon atmosphere. Light is produced by the recombination of electrons with ionized xenon atoms created by the flow of electrons across an arc formed between the anode and cathode. The housing is used to support the lamp, to provide protection from excess heat and light, and (in conjunction with a mirror) to collect and collimate light produced by the lamp.

Xenon arc lamps have significant current and voltage requirements, particularly at startup. For example, a CERMAX collimated xenon arc lamp (Model No. LX175F and LX175UV) requires a sequence of three high-voltage pulses for ignition: (1) a 23-kV, 50-ns pulse to start breakdown, (2) a 175-V, 300-ms boost pulse to warm up the arc, and (3) 12 V at 14 A to run the lamp. Additional specifications of this lamp are described in Appendices A and B of U.S. Provisional Patent Application Serial No. 60/197,324, filed Apr. 14, 2000, which is incorporated herein by reference. To obtain reliable lamp ignition, existing power supplies for xenon arc lamps require that either the power supply output section or the metal lamp enclosure be ungrounded. This arrangement is necessary to minimize the capacitive load that the power supply must drive. As explained below in more detail, the capacitive load is doubled when the power supply is grounded. When used this way, the ungrounded power supply or lamp enclosure spikes to one-half the lamp ignition voltage, or approximately 11.5 kV, during the lamp ignition process. This causes reliability problems in either the power supply (if the power supply is floating) or the lamp fan (if the enclosure is floating). In addition, it can be mechanically difficult to insulate the lamp enclosure due to the close proximity of other grounded structures.

FIG. 2 shows a portion of the ignition circuitry from an ASTEX power supply associated with generating the high-voltage ignition pulse. In the circuit of FIG. 2, ignition is initiated by applying a voltage of approximately 175 V across the +12-V and−12-V terminals. This charges capacitor C3 through resistor R1. When the voltage on the capacitor reaches the breakdown voltage of Diac D1, an LC oscillation is created through T1, C3, and D1. The output is stepped up by T1, and fed into the voltage doubler C2, D2, and D3, thereby providing the high voltage to charge the trigger capacitor C1. The ignition pulse is developed when C1 charges up to 7.5 kV, at which time the 7.5-kV spark gap flashes over. The capacitor discharges into a 1:4 autotransformer T2. The output pulse therefore would be 30 kV if there were no load, but the capacitive load of the lamp and housing reduces this voltage, as shown in FIG. 3.

In the design of FIG. 2, the power supply output section floats, i.e., it has no ground reference. As a result, in principle it drives the positive (+) and negative (−) contacts of the lamp symmetrically above and below ground by 11.5 kV during an ignition pulse. In fact, the split is determined by two factors: (1) stray capacitance from each lead to ground, and (2) corona discharge. The circuit tends to minimize corona by floating such that the discharge current is equal from each lead. This means that, potentially, either output can be near ground, and either output can be close to the maximum output voltage. If the split is relatively even, the design of FIG. 2 performs reasonably well.

The design of FIG. 2 has severe disadvantages. First, the circuitry on the output side of the power supply is referenced to the negative (−) end of the lamp, so that the voltage between all of the circuitry and the chassis pulses during ignition to approximately −11.5 kV in 25 ns. At 500 V/ns, a stray capacitance of 1 pF causes a displacement current of 0.5 A. High impedance nodes (FET gates) form a capacitive divider. Several parts of the power supply cannot withstand this voltage reliably, and so the power supply has reliability problems. Second, cooling fan failures occur with the design of FIG. 2. The fan is about 0.5 inches away from the positive (+) end of the lamp, and its leads contact the high-voltage leads to the lamp. Any asymmetry or insulation leakage can lead to discharges into the fan. Because the symmetry is determined by factors such as stray capacitance and corona, it is not guaranteed. Third, the lamp insulation and the insulating wire used on the lamp leads cannot withstand the full 23-kV ignition pulse. In short, while the design nominally works, it is unreliable and susceptible to anything that disturbs the symmetry.

ASTEX recently made modifications to improve the reliability of the supply. In particular, the negative lead of the power supply is now connected to chassis ground through a 3.3-nF capacitor. At the frequencies contained in the ignition pulse, this is essentially a short circuit. This eliminates the reliability problem, but completely unbalances the power supply, causing the entire ignition pulse to appear at the positive (+) lamp lead. It also causes a subtler problem: doubling the load seen by the power supply. To understand this problem, consider the load posed by the cable and housing capacitance and the output circuit of the power supply, as seen by the trigger capacitor. The 12-pF lamp capacitance may be ignored because it is constant in all cases. In the original design, the lamp floats relative to the housing, and the only ground connection is the capacitive coupling to the housing, as shown in FIG. 4. Because no other part of the circuit is connected to ground, the ground connections to the right of the lamp capacitances have only one effect: to connect the capacitors in series. Ignoring the 12-pF lamp capacitance, the load effective capacitance seen on the primary of T2 is therefore:

$${C}_{load} = {( \frac{21 + 7}{7} )}^{2} ( \frac{1}{\frac{1}{C} + \frac{1}{C}} ) = 16 ( \frac{C}{2} ) = 8 C \qquad ( 1 )$$

The first term is due to the transformer turns ratio, and the second term is due to the two capacitors in series.

FIG. 5 shows the effect of coupling the negative lamp lead to ground.

$${C}_{load} = {( \frac{21 + 7}{7} )}^{2} C = 16 C \qquad ( 2 )$$

Because there no longer are two capacitors in series, the effective load capacitance due to cable and housing capacitance doubles. Therefore, grounding the negative power supply lead causes at least two problems. First, it doubles the voltage that the wire and lamp insulation must withstand. Second, it doubles the load due to the cable and enclosure capacitance on the power supply.

These shortcomings with xenon arc lamp systems may assume even greater significance in academic and industrial settings that use xenon arc lamps as light sources for spectroscopic applications. In these settings, lamp failure can lead to costly downtime and/or require intervention that exposes potentially unskilled operators to dangers posed by the lamp and power supply. These dangers may be significant. For example, the gas in xenon arc lamps typically is under high pressure (about 10 atmospheres), so that explosion is always a danger. Moreover, as described above, the power supplies for xenon arc lamps may operate at very high currents (about 25 A) and voltages (about 20,000 to 40,000 V), so that electrocution and other health hazards are always a danger. In particular, the power supplies for arc lamps can deliver a lethal shock, and they also can produce transients that damage associated electronic components. Thus, there is a need for a xenon arc lamp system having an improved, more reliable power supply.

### SUMMARY OF THE INVENTION

The invention provides xenon arc lamp systems having improved high-voltage power supplies, particularly for use in spectroscopic applications.

### BRIEF DESCRIPTION OF THE FIGURES

FIG. 1 shows a xenon arc lamp and a typical housing for the lamp.

FIG. 2 shows an ignition portion of a prior art xenon arc lamp power supply.

FIG. 3 shows the effect of load capacitance on peak voltage in a power supply, such as the power supply shown in FIG. 1.

FIG. 4 shows schematically the capacitive loads in the power supply of FIG. 2.

FIG. 5 shows schematically the capacitive loads in the power supply of FIG. 2 with the negative lamp lead grounded.

FIG. 6 shows an ignition portion of a xenon arc lamp power supply according to aspects of the invention.

FIG. 7 shows schematically the capacitive loads in the power supply of FIG. 6.

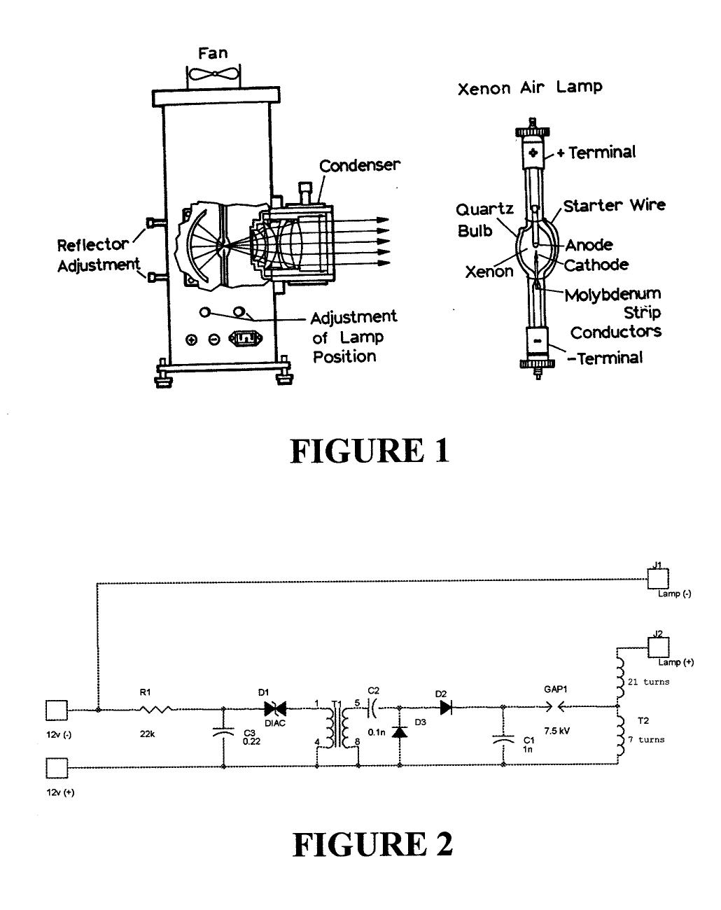

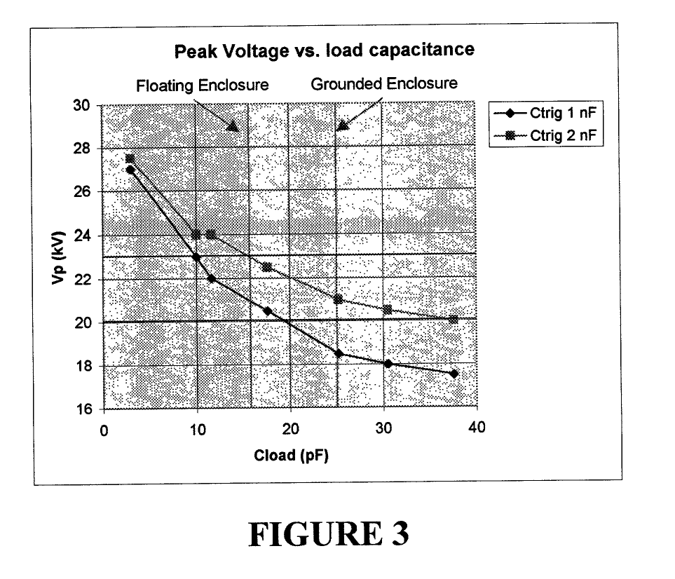

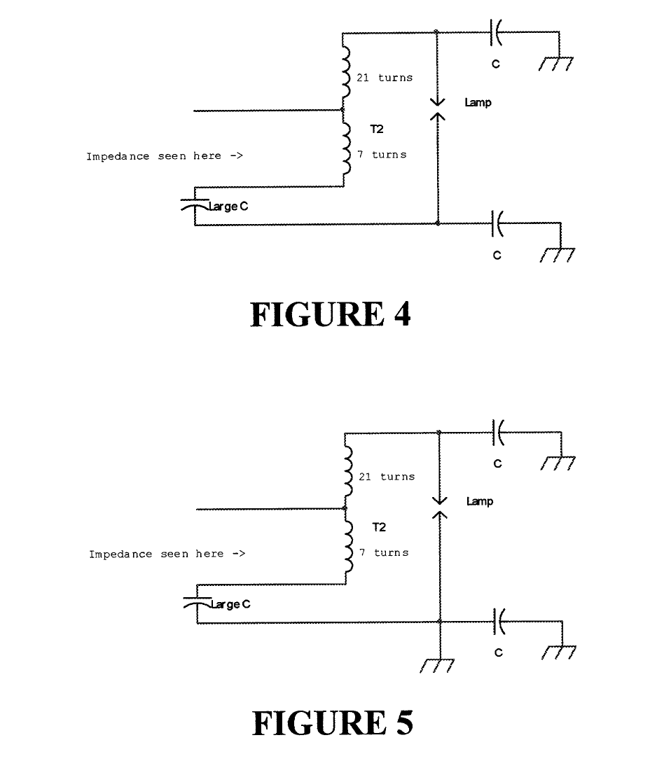

### Abbreviations

The following abbreviations may be used to denote units for current, voltage, time, and capacitance:

| Quantity/Prefix | | Abbreviation |
|---|---|---|
| Amp (measure of current) | | A |
| Volt (measure of voltage) | | V |
| Second (measure of time) | | s |
| Farad (measure of capacitance) | | F |
| milli | (10⁻³) | m |
| micro | (10⁻⁶) | μ |
| nano | (10⁻⁹) | n |
| pico | (10⁻¹²) | p |

### DETAILED DESCRIPTION

The invention provides xenon arc lamp systems having improved high-voltage power supplies. The invention may include the arc lamp systems, methods of triggering ignition of the arc lamp systems, and/or use of the arc lamp systems in various applications and apparatus, such as instruments for measuring photoluminescence.

One aspect of the invention includes arc lamp systems, such as a xenon arc lamp having a positive contact and a negative contact, and a power supply having an ignition circuit adapted to generate a voltage pulse to trigger ignition of the arc lamp. The ignition circuit may include a ground, and positive and negative lamp outputs adapted to connect to the positive and negative contacts, respectively, on the lamp. The positive and negative lamp outputs may be ground referenced. Alternatively, or in addition, the positive and negative lamp outputs may be substantially balanced relative to the ground. Alternatively, or in addition, the power supply may include a center-tapped transformer (such as an autotransformer), where the center tap is connected to ground. The lamp may include in each case a grounded or ungrounded lamp enclosure, among others.

Another aspect of the invention includes methods of triggering arc lamp ignition, such as applying a positive pulse to a positive terminal of a lamp and applying a negative pulse to a negative terminal of the lamp, where the pulses are referenced to a frame ground to reduce the capacitive load on the circuitry generating the pulses and to increase the amplitude of the pulses relative to pulses not referenced to ground. The lamp may include a conductive grounded housing or a conductive ungrounded housing, among others.

Yet another aspect of the invention includes an instrument for measuring photoluminescence, such as a xenon arc lamp as described above, a detector, and an optical relay structure configured to direct light from the arc lamp toward an examination site, and to direct photoluminescence light emitted by a sample at the examination site toward the director. The instrument further may include a frame ground, where the power supply ground is electrically coupled to the frame ground.

In each aspect of the invention, the voltage generated on each of the positive and negative contacts may be less than about 15 kV relative to ground, and/or the lamp may be selected from the group consisting of CERMAX and quartz-style lamps, among others.

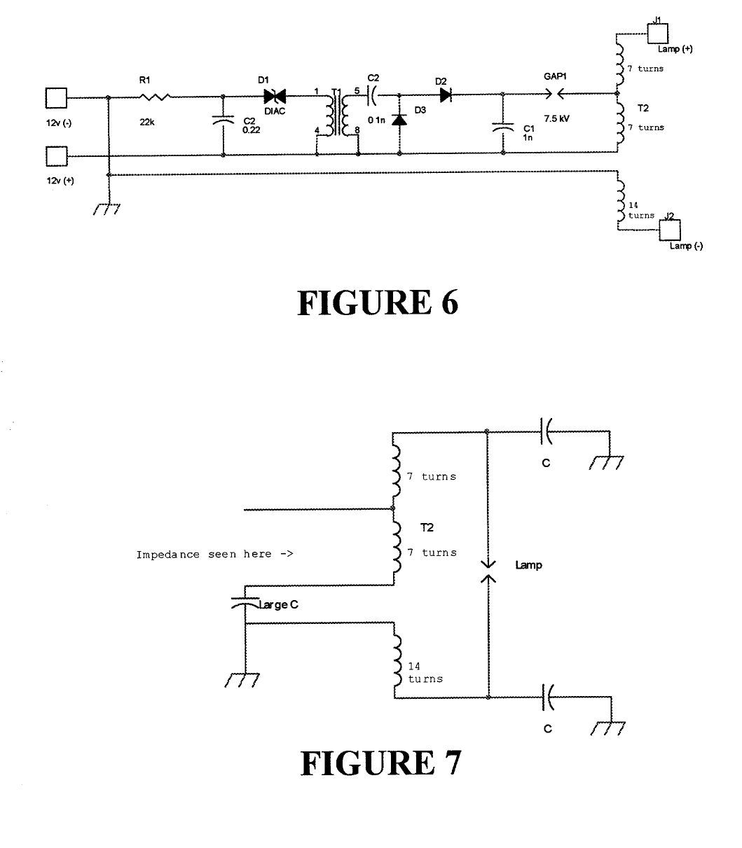

FIG. 6 shows a power supply circuit constructed in accordance with aspects of the invention. This circuit solves at least two problems. First, it provides a differential ignition pulse to the lamp (±11.5 kV), which also halves the effects of cable and housing capacitance. Second, circuitry of the power supply is referenced to chassis ground, rather than the negative (−) lamp lead. This was done by adding a 14-turn winding to the output transformer (T2 on the trigger PCB) and reducing the 21 turns to 7 turns. The relative voltages are established by the ratios of turns rather than any absolute value, and the invention includes adjusting the specific number of turns to suit the particular application requirements. The circuit ground is attached at the center. This circuit makes the ignition substantially pulse symmetric about ground, as desired.

FIG. 7 shows the effective capacitance load created by the circuit of FIG. 6. The effective load capacitance, due to cable and housing capacitance, is:

$${{C}_{load} ( \frac{7 + 7}{7} )}^{2} C + {( \frac{14}{7} )}^{2} C = 8 C \qquad ( 3 )$$

The effective capacitance is the same as in the ungrounded circuit of FIG. 2. Thus, this circuit has the advantages of the original circuit (lower effective load capacitance, lower peak output voltage relative to ground (+11.5 kV on one lead, −11.5 kV on the other)), and yet develops the same output voltage between the lamp terminals (23 kV). In addition, it has a significant additional advantage: the power supply circuit is referenced to ground, not −11.5 kV, for improved reliability. Implementation of the above circuit is relatively simple. In particular, T2 is wound slightly differently, essentially adding a tap. The same core, the same wire, and the same number of turns can be used as in the circuit of FIG. 2.

The following examples describe without limitation further aspects of the invention.

### EXAMPLE 1

To test this circuit, a printed circuit board (PCB) was laid out, built, and tested. It was beneficial to coat the PC board with an insulator such as varnish to reduce arcing and to achieve good high-voltage performance. Additionally, as an alternative mechanism for reducing the effective load capacitance, an insulated housing was built of acrylic rather than the metal used in the prior art.

On the bench, with a lamp housing that had no lamp module (i.e., that had heat sinks, etc., but no bulb, 9GJJ1608), voltage developed:

| Power Supply | Ignition voltage |
|---|---|
| Grounded negative, 1 nF | 21 kV |
| (Prior Art) | |
| Split output, 1 nF | 25.5 kV (+12.5 kV, −13 kV) |
| (FIG. 6) | |

In an instrument, average number of strikes before a successful ignition: Lamp statistics: (average number of clicks per ignition for 10 ignitions)

| | | Split output, | |
|---|---|---|---|
| | | 1 nF | Acrylic |
| | Grounded | (FIG. 6 w/ | Housing, 1 nF |
| | Negative, 1 nF | metal lamp | (w/Prior art |
| Lamp | (Prior Art) | housing) | circuit) |
| 0AJJ2541 | 16.8 | 4.2 | 5.5 |
| 9FJJ7101 | 6.3 | 1.0 | 4.6 |
| 0AJJ2532 | 7.9 | 2.4 | 3.0 |
| 0BJJ7049 | 1.5 | 1.4 | 1.0 |

The disclosed trigger circuit with split drive outperforms the prior art design with negative lead grounded, and the plastic housing. In particular, it provides greater reliability and flexibility in installation of the lamp in the instrument in which it is being used. It is equally applicable to CERMAX and quartz-style lamps.

### EXAMPLE 2

The invention includes apparatus and methods that employ a xenon arc lamp system as described above. For example, the xenon arc lamp system may be used as part of an instrument for spectroscopic analysis, including photoluminescence analysis. Suitable instruments and associated applications are described in any and all of the patents, patent applications, and other publications listed above under Cross-References and incorporated herein by reference, including, but not limited to, U.S. Pat. No. 6,097,025, issued Aug. 1, 2000; U.S. patent application Ser. No. 09/349,733, filed Jul. 8, 1999; and U.S. patent application Ser. No. 09/777,343, filed Feb. 5, 2001.

The disclosure set forth above encompasses multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious and directed to one of the inventions. These claims may refer to “an” element or “a first” element or the equivalent thereof; such claims should be understood to include incorporation of one or more such elements, neither requiring nor excluding two or more such elements. Inventions embodied in other combinations and subcombinations of features, functions, elements, and/or properties may be claimed through amendment of the present claims or through presentation of new claims in this or a related application. Such claims, whether directed to a different invention or to the same invention, and whether broader, narrower, equal, or different in scope to the original claims, also are regarded as included within the subject matter of the inventions of the present disclosure.

I claim:

1. A xenon arc lamp system, comprising:
a xenon arc lamp including a positive contact and a negative contact; and
a power supply including an ignition circuit adapted to generate a voltage pulse to trigger ignition of the arc lamp;
wherein the ignition circuit includes a ground, and positive and negative lamp outputs adapted to connect to the positive and negative contacts, respectively, on the lamp; and
wherein the positive and negative lamp outputs are ground referenced.

2. The system of claim 1, wherein the positive and negative lamp outputs are substantially balanced relative to the ground.

3. The system of claim 1, wherein the power supply includes a center tapped transformer, and wherein the center tap is connected to ground.

4. The system of claim 3, wherein the transformer is an autotransformer.

5. The system of claim 3, wherein the positive and negative lamp outputs are substantially balanced relative to the ground.

6. The system of claim 1, wherein the lamp includes a grounded lamp enclosure.

7. The system of claim 1, wherein the lamp is selected from the group consisting of CERMAX and quartz-style lamps.

8. The system of claim 1, wherein the voltage generated on each of the positive and negative contacts is less than about 15 kV relative to ground.

9. A xenon arc lamp system, comprising:
a xenon arc lamp including a positive contact and a negative contact; and
a power supply including an ignition circuit adapted to generate a voltage pulse to trigger ignition of the arc lamp;
wherein the ignition circuit includes a ground, and positive and negative lamp outputs adapted to connect to the positive and negative contacts, respectively, on the lamp; and
wherein the ignition circuit is configured to substantially balance positive and negative voltages on the positive and negative lamp outputs.

10. The system of claim 9, wherein the power supply includes a center tapped transformer, and wherein the center tap is connected to ground.

11. The system of claim 9, wherein the lamp is selected from the group consisting of CERMAX and quartz-style lamps.

12. The system of claim 9, wherein the voltage generated on each of the positive and negative contacts is less than about 15 kV relative to ground.

13. A xenon arc lamp system, comprising:
a xenon arc lamp including a positive contact and a negative contact; and
a power supply adapted to generate a voltage pulse to trigger ignition of the arc lamp,
wherein the ignition circuit includes a ground, and positive and negative lamp outputs adapted to connect to the positive and negative contacts, respectively, on the lamp; and
wherein the power supply includes a center-tapped transformer, the center tap being connected to ground.

14. The system of claim 13, wherein the transformer is an autotransformer.

15. The system of claim 13, wherein the lamp is selected from the group consisting of CERMAX and quartz-style lamps.

16. The system of claim 13, wherein the voltage generated on each of the positive and negative contacts is less than about 15 kV relative to ground.

17. A method of triggering arc lamp ignition comprising applying a positive pulse to a positive terminal of a lamp and applying a negative pulse to a negative terminal of the lamp, wherein the pulses are referenced to a frame ground to reduce the capacitive load on the circuitry generating the pulses and to increase the amplitude of the pulses relative to pulses not referenced to ground.

18. The method of claim 17, wherein the lamp includes a conductive housing and the housing is grounded.

19. The method of claim 17, wherein the lamp includes a conductive housing and the housing is ungrounded.

20. An instrument for measuring photoluminescence, comprising:
a xenon arc lamp including a positive contact and a negative contact;
a power supply including an ignition circuit, where the ignition circuit includes a ground and positive and negative lamp outputs adapted to connect to the positive and negative contacts, respectively, on the lamp, where the positive and negative lamp outputs are ground referenced;
a detector; and
an optical relay structure configured to direct light from the arc lamp toward an examination site, and to direct photoluminescence light emitted by a sample at the examination site toward the detector.

21. The instrument of claim 20, further comprising a frame ground, wherein the power supply ground is electrically coupled to the frame ground.
